(19) United States
(12) Patent Application Publication
(10) Pub. No.: US 2017/0008019 A1
(43) Pub. Date: Jan. 12, 2017

(54) Overspray Collection System

(71) Applicant: Verticon, LLC, Wheatridge, CO (US)

(72) Inventors: Michael W. Calahan, Arvada, CO (US); Kevin Michael Gillest, Arvada, CO (US); Kalvis Jaunarajs, Littleton, CO (US); Byron Henze, Idaho Springs, CO (US)

(21) Appl. No.: 14/796,847

(22) Filed: Jul. 10, 2015

(51) Int. Cl. B05B 15/04; B05B 15/12

(52) U.S. Cl. CPC B05B 15/0406; B05B 15/1225

(57) ABSTRACT

An overspray collection system comprises a hood designed to allow spray gun operation through the hood, an air flow system to pull air with entrained overspray, a vortex/cyclone to separate the air from the overspray and a collection container into which the overspray is deposited. An airflow control device such as an air hose, vacuum supply or vacuum chamber may assist by controlling an airflow within the can during spraying, thus providing that a higher percentage of the spray adheres to the can interior, allowing denser and more uniform coating.

### CROSS-REFERENCE TO RELATED APPLICATIONS

NA

### FIELD OF INVENTION

This invention relates generally to coating or spraying and specifically to the manufacture of cylindrical items such as cans/containers and the coating of the interior of such items.

### STATEMENT REGARDING FEDERALLY FUNDED RESEARCH

This invention was not made under contract with an agency of the US Government, nor by any agency of the US Government.

### BACKGROUND OF THE INVENTION

Modern coating of the interiors of objects relies upon spray gun technology. A typical spray gun has a barrel having a nozzle at the lower end and a feed mechanism at the upper end, often a body which is part of a recirculating loop of lacquer, paint and/or other coating.

Traditionally, the cans descend in a track into a rotating star wheel, which is oriented vertically. As the star wheel rotates, the cans pass in front of the spray gun, which has been adjusted for the size and shape of cans being sprayed, and the spray gun is activated by automated controls for a brief period of time (some milliseconds) during which it coats the interior of the can. The process continues during a production operation or production run (or during a shift) and coats the interiors of many hundreds of cans per minute. Various means and methods might be employed to speed up the act of spraying the can during a run, however, the present invention is not directed at that.

In most instances it is impossible to prevent a small amount of spray containing lacquer or coating (hereinafter either term is used) from failing to reach the interior surface of the can being coated. This spray may be entrained in air moving the wrong direction, it may be sprayed in the wrong direction initially or as a result of the gun falling out of alignment, it may be necessary due to the geometrical limitations of the gun or for other reasons. This “overspray” is a waste of lacquer obviously, what is more important is that it is an environmental issue of some importance.

An “environmental issue” is not necessarily limited to the modern green meaning of the term, although the overspray is a form of atmospheric pollution. What is of a more immediate concern is that the overspray is an unwelcome source of equipment fouling, jams, irregularity in output and is detrimental to worker efficiency and health. The overspray can coat all equipment in the immediate area to the point that it can be impossible to read or discern any fine details on the machinery, the buildup must be removed and the removal is normally an another source of lost production time and increased maintenance frustrations, costs, and more.

It would be preferable to provide a means of controlling the overspray in the unique conditions of can manufacture, in particular, in the technical area of interior coating of cylindrical bodies with coatings/lacquers.

### SUMMARY OF THE INVENTION

The present invention teaches an overspray control and collection system. The system has a deflector portion of a hood which forces any overspray into an air channel. Air flowing through the channel under suction may carry the entrained overspray with it, through and out of the hood and into a vortex chamber which whirls the air and overspray so that they are separated by centrifugal force. A collection container may then collect the overspray while the cleaned air is allowed to exhaust.

In one embodiment, the deflector portion of the hood has a slot therethrough to allow the spray gun nozzle to protrude into the same space as the container to be coated.

In other embodiments the slot may defined two hoods, left and right, so that overspray on both sides is collected. The hoods may sit close above the open top of a container to be coated.

The hoods may then lead the overspray into air intake channels under suction (partial vacuum), so that air and entrained overspray may pass through the two conduits and exit the hood through paired exhaust vacuum ports, attached to each conduit of each hood. Exhaust pipes may then carry the air and overspray (and maintain vacuum) to a vortex chamber which is dimensioned and configured to cause the air/overspray mixture to whirl and separate. One advantageous shape may be a partial conical interior with the vacuum source set at an angle or with vanes which force airflow in the desired configuration for separation.

In another embodiment, one or more airflow control devices may be used to control the flow of air within the container being sprayed. Control of the airflow, possibly including control over turbulence versus laminarity, allows the deposit of a higher percentage of the spray onto the interior surface of the container and loss of a lower percentage into the atmosphere or otherwise not adhering to the can wall, which in turn means use of less lacquer/coating, more uniform coating, denser coating and so on.

The airflow control device may be a vacuum chamber in which the container sits while being sprayed, may be a vacuum supply such a tube which administers negative pressure, or may be an air hose which delivers timed puffs/bursts of air into the container interior (for example timed positive pressure instead of/in addition to the negative pressure). The control device may further comprise a controller to control timing of the operation of the air flow control device.

These and many other aspects, advantages, embodiments and objectives of the present invention will be understood by reference to the following.

### SUMMARY IN REFERENCE TO THE CLAIMS

It is therefore one aspect, advantage, objective and embodiment of the present invention, in addition to those described above, to provide an overspray collection system for use with a spray gun, the spray gun oriented to spray into the interior of a cylindrical body, the system comprising:

a left hood and a right hood, the two hoods disposed adjacent but with a gap therebetween, such spray gun on one side of the gap, such cylindrical body on the other side of such gap, such spray passing through the gap from the spray gun to the cylindrical body;

each hood having a deflector, each deflector extending at an angle to such spray, whereby such overspray may be caught upon the deflectors;

each hood further having a vacuum conduit intake defined by the hood body and the hood's deflector, the vacuum conduit intake having a negative pressure therein, whereby air and entrained overspray may be drawn into the vacuum conduit intake;

each vacuum conduit intake further having a conduit to a vacuum exhaust port from the hood, whereby the air and such entrained overspray may be exhausted from each hood.

It is therefore one aspect, advantage, objective and embodiment of the present invention, in addition to those described above, to provide an overspray collection system further comprising:

a pair of exhaust pipes, one extending from each vacuum exhaust port, whereby the air and entrained overspray may be drawn from each vacuum exhaust port.

It is therefore one aspect, advantage, objective and embodiment of the present invention, in addition to those described above, to provide an overspray collection system further comprising:

a vortex body, the vortex body having a generally circular planform, the exhaust pipes entering the vortex body, whereby the air and entrained overspray may be drawn into such vortex body.

It is therefore one aspect, advantage, objective and embodiment of the present invention, in addition to those described above, to provide an overspray collection system wherein the vortex body further comprises:

at least one vortex inducing device attached to the vortex body, the vortex inducing device dimensioned and configured to cause a vortex of the air and entrained overspray within the vortex body, whereby the air and entrained overspray are separated.

It is therefore one aspect, advantage, objective and embodiment of the present invention, in addition to those described above, to provide an overspray collection system wherein the vortex inducing device further comprises one member selected from the group consisting of: angled entrances of the exhaust pipes, an angled final exhaust, an airfoil, or combinations thereof.

It is therefore one aspect, advantage, objective and embodiment of the present invention, in addition to those described above, to provide an overspray collection system wherein the pair of hoods are symmetrical.

It is therefore one aspect, advantage, objective and embodiment of the present invention, in addition to those described above, to provide an overspray collection system each hood further comprising:

at least one mounting device whereby each hood may be attached to a spray machine, the spray machine being attached to such spray gun.

It is therefore one aspect, advantage, objective and embodiment of the present invention, in addition to those described above, to provide an overspray collection system wherein the at least one mounting device comprises: a hole dimensioned and configured to receive a fastener.

It is therefore one aspect, advantage, objective and embodiment of the present invention, in addition to those described above, to provide an overspray collection system further comprising: a first air flow control device, the first air flow control device operative to control a flow of ambient air within such cylindrical body, thereby altering flow of such spray after such spray exits such spray gun, especially within such cylindrical body.

It is therefore one aspect, advantage, objective and embodiment of the present invention, in addition to those described above, to provide an overspray collection system for use with a spray gun, the spray gun oriented to spray into the interior of a cylindrical body, the system comprising:

a conduit disposed to receive such overspray at a first end;

the conduit having a negative pressure therein, whereby ambient air and such overspray may be sucked into the conduit;

the conduit having a second end entering a vortex chamber, whereby the ambient air and such overspray may be sucked into the vortex chamber;

the vortex chamber having a spin inducer causing the air and such overspray to whirl inside of the vortex chamber, whereby such overspray may separate from the ambient air;

a final exhaust at which the air may exit the vortex chamber.

It is therefore one aspect, advantage, objective and embodiment of the present invention, in addition to those described above, to provide an overspray collection system wherein the vortex inducer further comprises one member selected from the group consisting of: angled entrances of the exhaust pipes, an angled final exhaust, an airfoil, or combinations thereof.

It is therefore one aspect, advantage, objective and embodiment of the present invention, in addition to those described above, to provide an overspray collection system further comprising:

at least one exhaust pipe, the exhaust pipe connecting to an exhaust port through which the ambient air and entrained overspray may be drawn from each vacuum exhaust port.

It is therefore one more aspect, advantage, objective and embodiment of the present invention, in addition to those described above, to provide a overspray collection system further comprising:

at least one hood, the hood disposed adjacent to a gap, such spray gun on one side of the gap, such cylindrical body on the other side of such gap, such spray passing through the gap from the spray gun to the cylindrical body;

the hood having a deflector, the deflector extending at an angle to such spray, whereby such overspray may be caught upon the deflector;

the hood further having a vacuum conduit intake defined by the hood body and the deflector, the vacuum conduit intake having a negative pressure therein, whereby air and entrained overspray may be drawn into the vacuum conduit intake;

the vacuum conduit intake further having a conduit to the vacuum exhaust port from the hood, whereby the air and such entrained overspray may be exhausted from the hood.

It is therefore one more aspect, advantage, objective and embodiment of the present invention, in addition to those described above, to provide a spray control and overspray collection system for use with a spray gun, the spray gun oriented to spray into the interior of a cylindrical body, the system comprising:

a first air flow control device, the first air flow control device operative to control a flow of ambient air within such cylindrical body, thereby altering flow of such spray after such spray exits such spray gun, especially within such cylindrical body.

It is therefore one more aspect, advantage, objective and embodiment of the present invention, in addition to those described above, to provide a spray control and overspray collection system for use with a spray gun, the spray gun oriented to spray into the interior of a cylindrical body, the system comprising:

a first air flow control device, the first air flow control device operative to control a flow of ambient air within such cylindrical body, thereby altering flow of such spray after such spray exits such spray gun, especially within such cylindrical body.

It is therefore one more aspect, advantage, objective and embodiment of the present invention, in addition to those described above, to provide a spray control and overspray collection system for use with a spray gun, the spray gun oriented to spray into the interior of a cylindrical body, wherein such first air flow control device is one member selected from the group consisting of: an air hose oriented, dimensioned and configured to provide a timed burst of ambient air into such cylindrical body; a vacuum supply oriented dimensioned and configured to provide a negative pressure to ambient air within such cylindrical body; a vacuum chamber enclosing such cylindrical body, and combinations thereof.

It is therefore one more aspect, advantage, objective and embodiment of the present invention, in addition to those described above, to provide a spray control and overspray collection system for use with a spray gun, the spray gun oriented to spray into the interior of a cylindrical body, wherein such first air flow control device further comprises: a controller operative to control operation of the first air flow control device in the time domain.

It is therefore one more aspect, advantage, objective and embodiment of the present invention, in addition to those described above, to provide a spray control and overspray collection system for use with a spray gun, the spray gun oriented to spray into the interior of a cylindrical body, wherein the first air flow control device is further operative to alter the degree of turbulence of the airflow within such cylindrical body, whereby such spray is applied to an interior surface of such cylindrical body in a denser and more uniform application of the coating.

It is therefore one more aspect, advantage, objective and embodiment of the present invention, in addition to those described above, to provide a spray control and overspray collection system for use with a spray gun, the spray gun oriented to spray into the interior of a cylindrical body, wherein the first air flow control device is further operative to alter the degree of laminar airflow within such cylindrical body, whereby an increased percentage of such spray is applied to an interior surface of such cylindrical body when compared to spray without use of the first air flow control device.

It is therefore one more aspect, advantage, objective and embodiment of the present invention, in addition to those described above, to provide a spray control and overspray collection system for use with a spray gun, the spray gun oriented to spray into the interior of a cylindrical body, further comprising:

a left hood and a right hood, the two hoods disposed adjacent but with a gap therebetween, such spray gun on one side of the gap, such cylindrical body on the other side of such gap, such spray passing through the gap from the spray gun to the cylindrical body;

each hood having a deflector, each deflector extending at an angle to such spray, whereby such overspray may be caught upon the deflectors;

each hood further having a vacuum conduit intake defined by the hood body and the hood's deflector, the vacuum conduit intake having a negative pressure therein, whereby such airflow exiting such cylindrical body and entrained overspray may be drawn into the vacuum conduit intake;

each vacuum conduit intake further having a conduit to a vacuum exhaust port from the hood, whereby the air and such entrained overspray may be exhausted from each hood.

### BRIEF DESCRIPTION OF THE DRAWINGS

FIG. 1 is a partially cross-sectional view of a spray machine with a spray gun spraying through two hoods according to a first embodiment of the present invention.

FIG. 2 is an elevated perspective view of a single hood according to a second embodiment of the present invention.

FIG. 3 is a raised perspective cross-sectional view of a single hood according to a third embodiment of the present invention.

FIG. 4 is a cross-sectional planform view of a single hood according to a fourth embodiment of the invention.

FIG. 5 is a side-view in cross-section of a single hood according to a fifth embodiment of the invention.

FIG. 6 is a frontal simplified block diagram of a spray machine showing the hoods, gun, star wheel, can pockets, a vortex body and the flow of air and entrained overspray through the system.

FIG. 7 is a frontal view of a vortex body according a sixth embodiment of the present invention.

FIG. 8 is a simplified cross-sectional front view of a vortex body and exhaust pipes according to a seventh embodiment of the present invention.

FIG. 9 is a simplified view of a coating machine, including the star wheel, an alternative hood embodiment of the invention, an alternative vortex embodiment of the invention, and a collection bin embodiment of the invention.

FIG. 10 is a cross-sectional diagram showing the alternative hood embodiment of the invention, with an exemplary spray gun.

FIG. 11 is a cross-sectional view of the alternative hood embodiment of the invention, showing multiple air flow paths therethrough.

FIG. 12 is another cross-sectional view of a hood embodiment of the invention.

FIG. 13 is an orthogonal view of a hood embodiment of the invention.

FIG. 14 is a cross-sectional view of a container, spray gun, lacquer spray, and air hose of another alternative embodiment of the invention.

FIG. 15 is a cross-sectional view of a container, spray gun, spray, and vacuum tube of yet another alternative embodiment of the invention.

FIG. 16 is a cross-sectional view of a container, spray gun, spray, and vacuum chamber of yet another alternative embodiment of the invention.

### INDEX OF REFERENCE NUMERALS

Spray gun 100
Gap 102
Spray 104
Hood 106
Vacuum conduit intake 108
Deflector 110
Hood profile 206
Deflector 210
Hood 300
Vacuum conduit 302
Vacuum port/exhaust 304
Mounting hole 306
Hood 400
Vacuum inlet/conduit 402
Overspray/air flow 404
Conduit to port 406
Overspray & air flow 408
Mounting hole 410
Hood 500
Vacuum conduit 502
Air & overspray flow 504
Conduit to exhaust 506
Air/overspray flow 508
Star wheel 602
Spray gun 604
Hood 606
Vortex chamber 608
Overspray flow from can to hood 610
Overspray flow from hood to vortex chamber 612
Exhaust air 614
Vortex chamber 700
Exhaust 702
Spray gun 800
Hood deflector (left) 802
Hood deflector (right) 804
Exhaust conduit to vortex 806
Exhaust conduit to vortex 808
Spin inducer 810
Spin inducer 812
Chamber interior 814
Exhaust air 816
Star wheel 902
Direction of star wheel rotation 904
Hood 906
Vortex 908
Air flow
Debris (overspray) flow 912
Collection bin 914
Backscatter block hood 1002
Spray gun 1004
Air flow paths 1106
Hood cavity (space for cans to rotate in star wheel 1202
Vent opening (slant portion) 1204
Spray gun 1400
Air hose 1402
Container 1404
Spray 1406
Spray gun 1500
Spray 1502
Container 1504
Air flow to vacuum 1506
Vacuum supply 1508
Spray gun 1600
Spray 1602
Container 1604
Vacuum atmosphere 1606
Air flow to vacuum 1608
Vacuum chamber 1610

### DETAILED DESCRIPTION

Glossary

As used herein a spray gun may be any commercially available or used device which sprays very fine droplets/particles of lacquer, coating, paint or the like used to coat part or all of a cylindrical item of manufacture, including a container such as a can. This is the pressures part of a spray machine.

A spray gun barrel is the part which actually ejects paint, lacquer or coating into the nozzle. It may be largely cylindrical with numerous features such as extensions, indents, additions and so on, most particularly including a feed-body near the rear end, the feed body being the structure which accepts liquid spray material into the cylindrical body from a feed system.

The feed source may be a recirculating loop containing the material or may be a one way feed line (recirculation being quite common in can coating processes).

The spray gun barrel will have a nozzle and/or nozzle end, usually the end closest to the cylindrical item of manufacture, which reduces the liquid flowing inside the barrel to a fine spray of droplets/particles of the liquid. This nozzle end must have a clear field of fire to the item of manufacture, unblocked by any equipment which would prevent uniform coating of the container/product.

As used herein a cylindrical item of manufacture may refer to any object, particularly including packaging for consumer goods, having a shape which is a generally cylindrical body with an end which is open at least briefly during manufacture, and which requires such a coating or lacquer or paint on the inside/interior surface. Examples include aluminum and steel cans (for beverages or food) but this term includes any item, regardless of material, which may be coated internally. Aluminum cans are well known for requiring coating merely to hold more customary types of beer, food, soft drinks, juice and other liquids.

Overspray refers to the excess spray, mis-aimed spray or other spray which the nozzle of the spray gun ejects but which ends up not on the appropriate surface for coating. Most generally, this overspray will be present in the ambient air of the pocket of the star wheel, at least for a short period of time.

Inlets, conduits, ports, and so on have their ordinary meanings.

A vortex/cyclone as used herein refers to a body having a hollow interior, the hollow interior being dimensioned and configured to cause the rapid rotation of air passing through. Such vortices may be generally cylindrical, but may also be conical, frusta-conical and so on. The arrangement of the source of vacuum and the source of air may be enough, combined with the geometry of the vortex, to cause the rotation/whirl of the air, however, vanes or propelling devices may be used in the vortex as well.

It will be understood that the vortex will be of sufficient efficiency to cause a separation of the overspray from the air carrying it. This will generally be termed “centrifugal” (centripetal, “centrifical”) but within the scope of the term as used herein may well simply be caused by the whirling air forcing the overspray, which may be quite sticky, to contact objects such as side walls, screens, filters and so on.

Vacuum in this application does not refer to a vacuum particularly close to perfect, the vacuum may be quite modest as long as it produces the desired suction of the air into the conduits and the vortex. The vacuum (negative pressure) may by itself be sufficient to produce the whirling of the air in the vortex. Vacuum in this case may within the scope of the invention be generated by a “vacuum” (the device) but the term is not so intended herein.

Glossary End

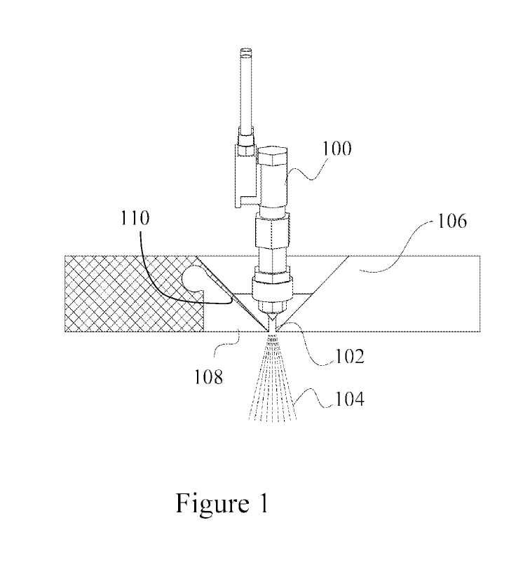

FIG. 1 is a partially cross-sectional view of a spray machine with a spray gun spraying through two hoods according to a first embodiment of the present invention.

Spray gun 100 has a nozzle pointing downward, spray 104, including some which will not reach the target surface, may be seen moving downward in the figure. The nozzle extends to gap 102. The nozzle may be quite close to the gap 102 on either side, and need not be exactly centered in the gap, though that may be preferable.

Hood 106 may be seen in partial cross section and it will be appreciated that there are actually two hoods or vacuum chambers present, one on either side of the nozzle and gap 102. The vacuum conduit intake 108 and deflector 110 are thus matched by similar or identical intakes and deflectors on the other side, however, these are not visible due to the other side of the hood being shown without cross section.

It will be understood that any spray which begins to follow a curved trajectory upward to escape the cup-like shape of the item of manufacture/container/can will either impact the deflector 110 or will more likely be sucked into the vacuum conduit intake 108: the deflector 110 acts not only to physically block some overspray but more importantly it acts to direct airflow in the desired direction: into the intake 108.

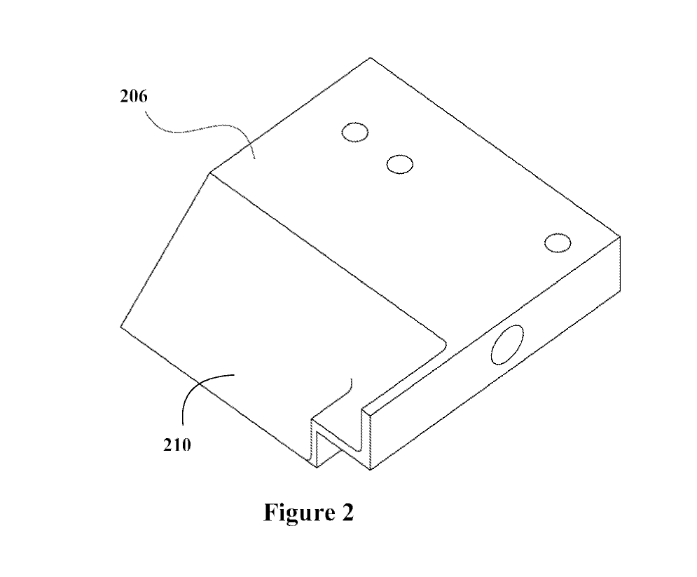

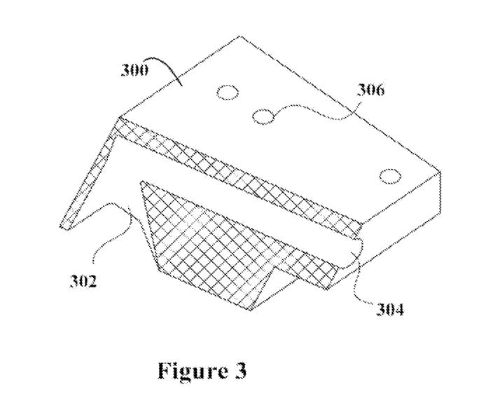

FIG. 2 is an elevated perspective view of a single hood according to a second embodiment of the present invention. This embodiment may be one potential alternative embodiment. Hood profile 206 of this embodiment may be seen. The deflector 210 and the shape of the device in perspective help show the air flow, however, this is better seen in FIG. 3.

FIG. 3 is a raised perspective cross-sectional view of a single hood according to a third embodiment of the present invention. Hood 300 has vacuum conduit 302 passing through the body of the hood from the vacuum intake (not numbered in this diagram) to the vacuum port/exhaust 304. In addition, mounting hole 306 is seen, which may be used for securing the device to a spray machine which is suitable for installation.

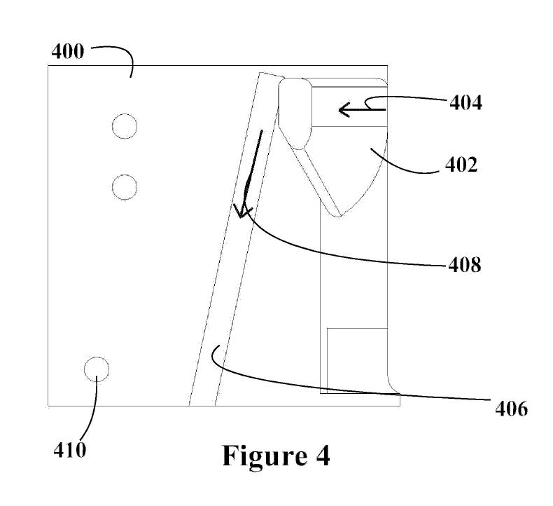

FIG. 4 is a cross-sectional planform view of a single hood according to a fourth embodiment of the invention.

Hood 400 has vacuum inlet/conduit 402 leading to the conduit 406, which in turn leads to the exhaust port. Overspray/air flow 404/408 flows through the conduit inlet 402 and the conduit to exhaust port 406.

Mounting hole 410 may be seen as well, part of another possible pattern of mounting holes. Various arrangements for mounting in alternative to holes may be used within the scope of the invention.

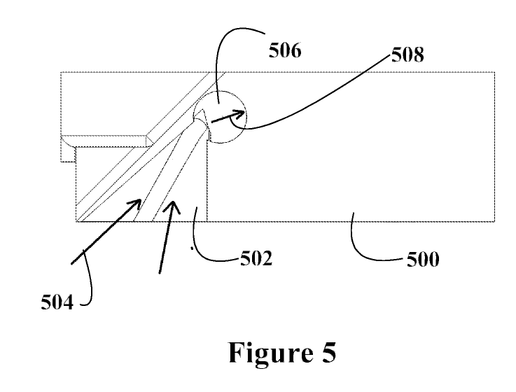

FIG. 5 is a side-view in cross-section of a single hood according to a fifth embodiment of the invention.

Hood 500 has the same inlet area, vacuum conduit 502 into which air & overspray flow 504 may pass, after which the vacuum will cause it to enter the conduit to exhaust 506, shown by air/overspray flow arrow 508.

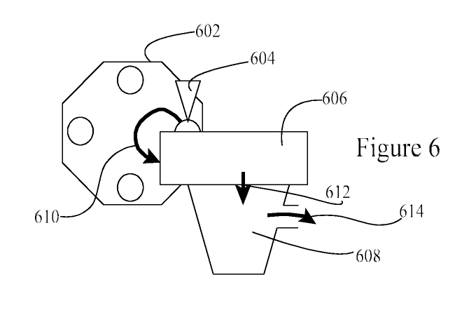

FIG. 6 is a frontal simplified block diagram of a spray machine showing the hoods, gun, star wheel, can pockets, a vortex body and the flow of air and entrained overspray through the system. In this preferred embodiment and best mode now contemplated, details are deprecated in favor of the overall structures of the invention.

Star wheel 602 (having only 4 pockets, most have more than 4 pockets) is arrayed vertically, with spray gun 604 shown in simplified form firing into a container in one pocket. Hood 606 is depicted as a single hood which covers only half of the pocket: this is for clarity, in most preferred embodiments the entire spray and pocket will be covered and thus invisible.

Vortex chamber 608 may be seen below the hood 606.

In use, overspray flow from can to hood 610 will swirl to a limited degree, but will actually be contained within the hood, this is the purpose of the hood. The hood 606 may in fact fit so closely to the item of manufacture that it largely or wholly obscures/covers the open end of the cylinder, or it may in fact seal thereto in yet further alternative embodiments, or it may be fairly “loose” and further away with a gap therebetween. The invention is not limited to the distance from the hood to the container open end.

Overspray flow from hood 606 to vortex chamber 608 is shown by arrow 612, and exhaust air by arrow 614. This very general structure to the invention is thus laid out with the key components shown.

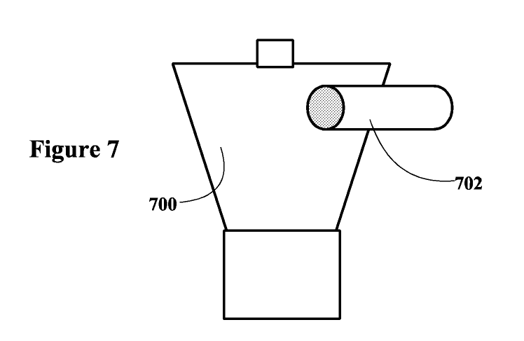

FIG. 7 is a frontal view of a vortex body according a sixth embodiment of the present invention. In this embodiment the primary source of rotation of the air and overspray debris is the exhaust 702, which is arranged at an angle and is furthermore the source of negative pressure (soft vacuum). The combination will cause the whirl/rotation and thus the separation of the droplets of overspray and air. It is entirely possible, depending upon the coating/lacquer in use, that the droplets will in fact already be particles at this point, however the term droplet may include droplets which have partially or wholly hardened.

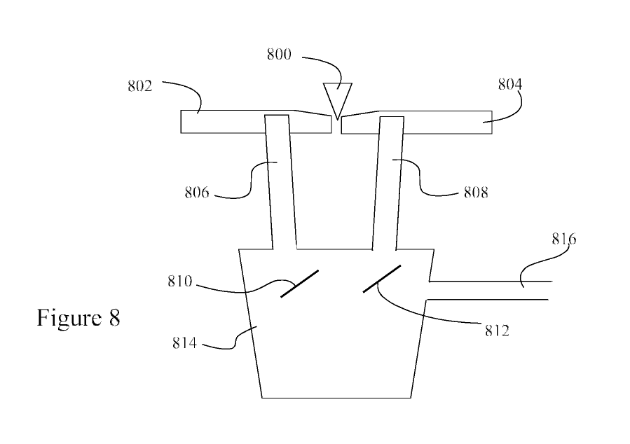

FIG. 8 is another simplified cross-sectional front view of a vortex body and exhaust pipes according to a seventh embodiment of the present invention. This is also a best mode now contemplated and preferred embodiment.

Spray gun 800 projects into the gap between hood deflector (left) 802 and hood deflector (right) 804. The star wheel and cylindrical item of manufacture are not shown in FIG. 8. Exhaust conduit to vortex 806 and exhaust conduit to vortex 808 send overspray and air to the vortex chamber interior 814.

Spin inducer 810 and spin inducer 812 may be simple vanes which deflect the entering air/overspray into a rotational motion. Note that these vanes may also serve as collectors of overspray which impacts them, which in some embodiments may be desirable and in other embodiments may be undesirable, all within the scope of the invention.

Chamber interior 814 exhausts via exhaust 816.

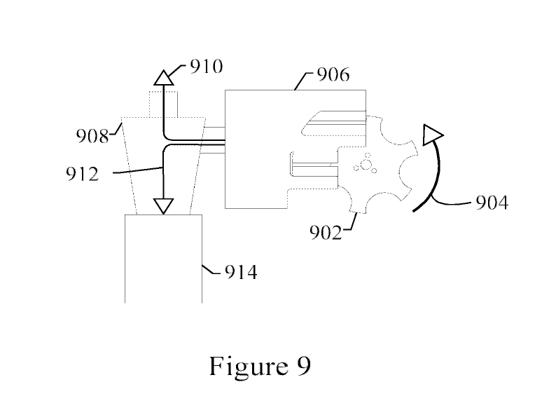

FIG. 9 is a simplified view of a coating machine, including the star wheel, an alternative hood embodiment of the invention, an alternative vortex embodiment of the invention, and a collection bin embodiment of the invention.

Star wheel 902 rotates as shown by arrow 904, partially underneath (within, obscured by, covered by,) hood 906. With the spray guns dismounted as shown, the two gaps and in fact four different hood airflows necessary to cover two pockets of the 6 pocket star wheel may be seen. The underside of the gaps will of course be the inlet air conduits shown previously. Air from the hood 906 will enter vortex 908 under suction, be separated, and air flow 910 may exhaust while debris (overspray) flow 912 may fall, drip or otherwise enter the collection bin 914. By having a separate collection bin 914, the machine may more easily be cleaned, overspray disposed of and so on. The collection bin 914 is depicted as a cylindrical body but may be any convenient shape within the scope of the invention.

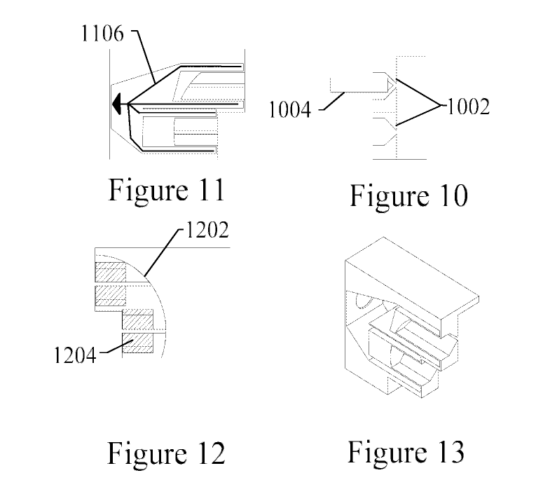

FIG. 10 is a cross-sectional diagram showing the alternative hood embodiment of the invention, with an exemplary spray gun.

Backscatter block/hood 1002 blocks almost all view of the cans as they are sprayed, leaving only a small gap for spray gun 1004. In this two gun embodiment, one gun has been dismounted for clarity.

FIG. 11 is a cross-sectional view of the alternative hood embodiment of the invention, showing multiple air flow paths therethrough. Air flow paths in plenum 1106 are actually four in number, two from each pocket. Note that alternative air flow paths may be used, for example three may be used by combining the two center flow paths if pocket geometry should allow this (not necessarily the most probable shape, however), or additional air flow paths may be employed. The plenum/air flow paths 1106 shown may be present if advantageous for airflow or omitted if the buildup of overspray occurs and so on. All of these alternatives may be within the scope of the invention.

FIG. 12 is another cross-sectional view of a hood embodiment of the invention. In this case the “star wheel facing side” or “underside” (however, star wheels and hoods are likely to be vertical) is shown. Hood cavity 1202 is a space for cans to rotate in the star wheel (e.g. 902 of FIG. 9) and it will be noted that it may advantageously closely match the travel of the cans in the wheel (being circular as shown or other shape matching the can motion).

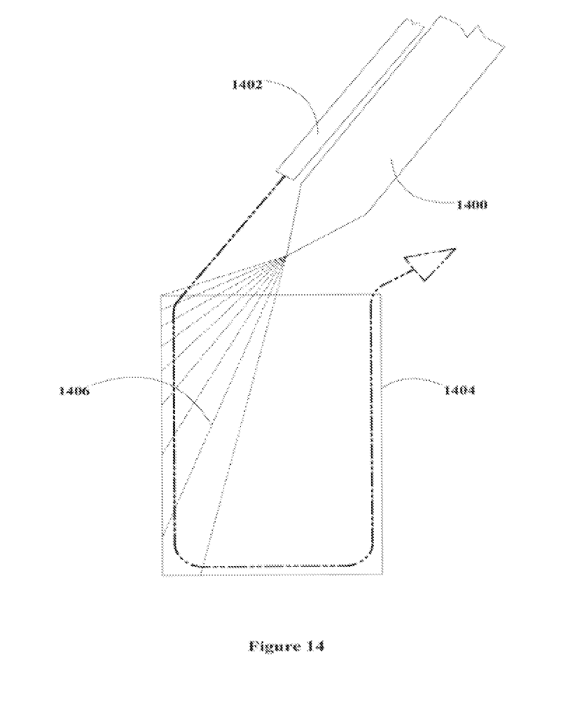

Vent opening (slant portion) 1204 is the deflector which guides air and blocks overspray in the desired manner discussed previously. FIG. 13 is an orthogonal view of a hood embodiment of the invention which offers a better view of the device.

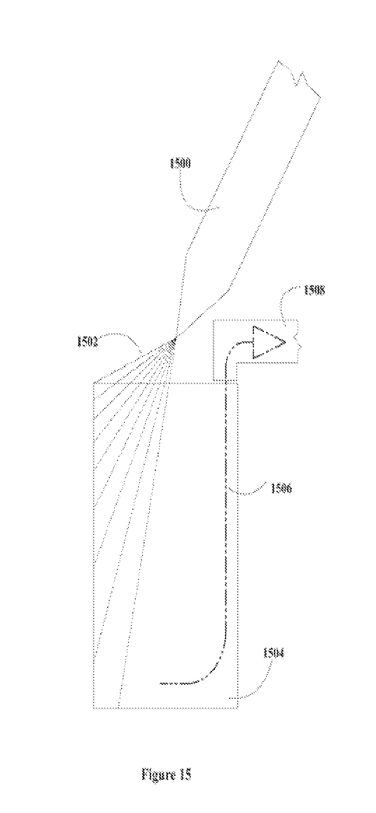

FIG. 14 is a cross-sectional view of a container, spray gun, lacquer spray, and air hose of another alternative embodiment of the invention. Spray gun 1400 delivers spray 1406 into container 1404.

A certain percentage of spray 1406 will impact the interior surface of the container and become part of the coating. However, a percentage of the spray 1406 will in fact swirl with the ambient air and be lost to the atmosphere, or become overspray, etc. Thus, one advantage of the present invention is to control an airflow within the container, whereby the percentage of applied spray may be increased in comparison to a spray without control of the ambient airflow. This may or may not particularly involve control over degree of turbulence or degree of laminar air flow, but in either case the result will be decreased use of coating, increased density of coating, and more uniform coating.

Air hose 1402 may thus be pointed into the cylindrical body to deliver timed (or continuous) bursts of air to control/alter airflow within the body.

FIG. 15 is a cross-sectional view of a container, spray gun, spray, and vacuum tube of yet another alternative embodiment of the invention. Spray gun 1500, spray 1502 and container 1504 are much as previously described, however, in this case instead of an ambient pressure flow or a positive pressure flow, a negative relative pressure air flow to vacuum 1506 is provided, usually by a vacuum supply 1508, which may be a vacuum tube, the hoods described previously, a vacuum generator at the end of the collection system which causes negative pressure from the collection can, through the vortex, conduits, hood and finally into the container interior, and so on.

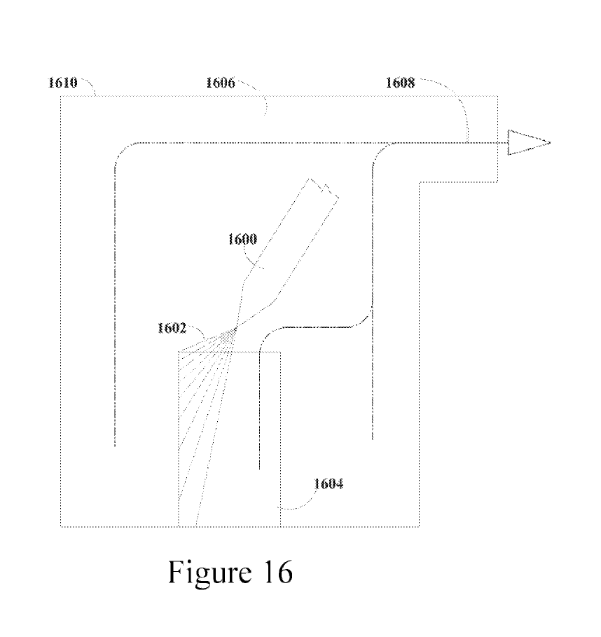

FIG. 16 is a cross-sectional view of a container, spray gun, spray, and vacuum chamber of yet another alternative embodiment of the invention. In this case, spray gun 1600, spray 1602 and container 1604 may all be found within a lower atmospheric pressure zone 1606, again with the presence of an air flow to vacuum 1608. In this case, the entire area, including parts or all of the spray gun, parts or all of the can pocket, parts or all of the star wheel, the overall machine etc., may be enclosed within vacuum chamber 1610.

Note that these methods are not mutually exclusive and in embodiments may be used together.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

We claim:

1. An overspray collection system for use with a spray gun, the spray gun oriented to spray into the interior of a cylindrical body, the system comprising:
a left hood and a right hood, the two hoods disposed adjacent but with a gap therebetween, such spray gun on one side of the gap, such cylindrical body on the other side of such gap, such spray passing through the gap from the spray gun to the cylindrical body;
each hood having a deflector, each deflector extending at an angle to such spray, whereby such overspray may be caught upon the deflectors;
each hood further having a vacuum conduit intake defined by the hood body and the hood's deflector, the vacuum conduit intake having a negative pressure therein, whereby air and entrained overspray may be drawn into the vacuum conduit intake;
each vacuum conduit intake further having a conduit to a vacuum exhaust port from the hood, whereby the air and such entrained overspray may be exhausted from each hood.

2. The overspray collection system of claim 1, further comprising:
a pair of exhaust pipes, one extending from each vacuum exhaust port, whereby the air and entrained overspray may be drawn from each vacuum exhaust port.

3. The overspray collection system of claim 2, further comprising:
a vortex body, the vortex body having a generally circular planform, the exhaust pipes entering the vortex body, whereby the air and entrained overspray may be drawn into such vortex body.

4. The overspray collection system of claim 3, wherein the vortex body further comprises:
at least one vortex inducing device attached to the vortex body, the vortex inducing device dimensioned and configured to cause a vortex of the air and entrained overspray within the vortex body, whereby the air and entrained overspray are separated.

5. The overspray collection system of claim 4, wherein the vortex inducing device further comprises one member selected from the group consisting of: angled entrances of the exhaust pipes, an angled final exhaust, an airfoil, or combinations thereof.

6. The overspray collection system of claim 1, wherein the pair of hoods are symmetrical.

7. The overspray collection system of claim 1, each hood further comprising:
at least one mounting device whereby each hood may be attached to a spray machine, the spray machine being attached to such spray gun.

8. The overspray collection system of claim 7, wherein the at least one mounting device comprises: a hole dimensioned and configured to receive a fastener.

9. The overspray collection system of claim 8, further comprising:
a first air flow control device, the first air flow control device operative to control a flow of ambient air within such cylindrical body, thereby altering flow of such spray after such spray exits such spray gun, especially within such cylindrical body.

10. An overspray collection system for use with a spray gun, the spray gun oriented to spray into the interior of a cylindrical body, the system comprising:
a conduit disposed to receive such overspray at a first end;
the conduit having a negative pressure therein, whereby ambient air and such overspray may be sucked into the conduit;
the conduit having a second end entering a vortex chamber, whereby the ambient air and such overspray may be sucked into the vortex chamber;
the vortex chamber having a spin inducer causing the air and such overspray to whirl inside of the vortex chamber, whereby such overspray may separate from the ambient air;
a final exhaust at which the air may exit the vortex chamber.

11. The overspray collection system of claim 10, wherein the vortex inducer further comprises one member selected from the group consisting of: angled entrances of the exhaust pipes, an angled final exhaust, an airfoil, or combinations thereof.

12. The overspray collection system of claim 11, further comprising:
at least one exhaust pipe, the exhaust pipe connecting to an exhaust port through which the ambient air and entrained overspray may be drawn from each vacuum exhaust port.

13. The overspray collection system of claim 12, further comprising:
at least one hood, the hood disposed adjacent to a gap, such spray gun on one side of the gap, such cylindrical body on the other side of such gap, such spray passing through the gap from the spray gun to the cylindrical body;
the hood having a deflector, the deflector extending at an angle to such spray, whereby such overspray may be caught upon the deflector;
the hood further having a vacuum conduit intake defined by the hood body and the deflector, the vacuum conduit intake having a negative pressure therein, whereby air and entrained overspray may be drawn into the vacuum conduit intake;
the vacuum conduit intake further having a conduit to the vacuum exhaust port from the hood, whereby the air and such entrained overspray may be exhausted from the hood.

14. The overspray collection system of claim 13, further comprising:
a first air flow control device, the first air flow control device operative to control a flow of ambient air within such cylindrical body, thereby altering flow of such spray after such spray exits such spray gun, especially within such cylindrical body.

15. A spray control and overspray collection system for use with a spray gun, the spray gun oriented to spray into the interior of a cylindrical body, the system comprising:
a first air flow control device, the first air flow control device operative to control a flow of ambient air within such cylindrical body, thereby altering flow of such spray after such spray exits such spray gun, especially within such cylindrical body.

16. The spray control and overspray collection system of claim 15, wherein such first air flow control device is one member selected from the group consisting of: an air hose oriented, dimensioned and configured to provide a timed burst of ambient air into such cylindrical body; a vacuum supply oriented dimensioned and configured to provide a negative pressure to ambient air within such cylindrical body; a vacuum chamber enclosing such cylindrical body, and combinations thereof.

17. The spray control and overspray collection system of claim 16, wherein such first air flow control device further comprises: a controller operative to control operation of the first air flow control device in the time domain.

18. The spray control and overspray collection system of claim 17, wherein the first air flow control device is further operative to alter the degree of turbulence of the airflow within such cylindrical body, whereby such spray is applied to an interior surface of such cylindrical body in a denser and more uniform coating.

19. The spray control and overspray collection system of claim 17, wherein the first air flow control device is further operative to alter the degree of laminar airflow within such cylindrical body, whereby an increased percentage of such spray is applied to an interior surface of such cylindrical body when compared to spray without use of the first air flow control device.

20. The spray control and overspray collection device of claim 17, further comprising:
a left hood and a right hood, the two hoods disposed adjacent but with a gap therebetween, such spray gun on one side of the gap, such cylindrical body on the other side of such gap, such spray passing through the gap from the spray gun to the cylindrical body;
each hood having a deflector, each deflector extending at an angle to such spray, whereby such overspray may be caught upon the deflectors;
each hood further having a vacuum conduit intake defined by the hood body and the hood's deflector, the vacuum conduit intake having a negative pressure therein, whereby such airflow exiting such cylindrical body and entrained overspray may be drawn into the vacuum conduit intake;
each vacuum conduit intake further having a conduit to a vacuum exhaust port from the hood, whereby the air and such entrained overspray may be exhausted from each hood.
